(19) United States
(12) Patent Application Publication
(10) Pub. No.: US 2005/0075010 A1
(43) Pub. Date: Apr. 7, 2005

(54) Electrical connector

(75) Inventors: Sheng Ho Yang, Hsintien (TW); Chiu Ping Weng, Hsintien (TW)

Correspondence Address: BRUCE H. TROXELL, SUITE 1404, 5205 LEESBURG PIKE, FALLS CHURCH, VA, 22041, US

(73) Assignee: Advanced Connectek Inc.

(21) Appl. No.: 10/857,839

(22) Filed: Jun. 2, 2004

(30) Foreign Application Priority Data
Oct. 3, 2003 (TW) 092217779

(51) Int. Cl. H01R 13/627

(52) U.S. Cl. 439/607

(57) ABSTRACT

An electrical connector suitable for use in applications such as cellular phones, PDAs, etc. is provided. The connector comprises a core assembly, a terminal assembly, and a substantially parallelepiped housing including a latch mechanism on a top, the latch mechanism including two auxiliary latches adjacent both sides and a central main latch. Each latch has a slightly inclined arm and a tapered projection at an open end of arm. The main latch is extended from a rear of the top of the housing toward a forward opening of the housing. The latches are extended to face the forward opening in an inside out manner as to increase the fastening of the connector in the port of an electrical device. The times of plugging and unplugging the connector can be increased significantly.

### BACKGROUND OF THE INVENTION

1. Field of The Invention

The present invention relates to electrical connectors and more particularly to such an electrical connector having an improved main latch on the housing suitable for applications such as cellular phones, PDAs (Personal Digital Assistants), etc.

2. Description of Related Art

This is an information age particularly an e-world as time evolves. Over the past several decades there has been a simultaneous growth in communication technology and electronics, leading to an increasing use of mobile communication products. For example, data transfer between two parties has advanced from sending a floppy disk from a sender to a recipient in the early days to sending data over the Internet nowadays. Moreover, wireless online is made possible. In addition, more and more compact, multi-functional, and inexpensive mobile communication products are commercially available and are gaining popularity quickly. Accordingly, the functions of associated products such as electrical connectors have to be enhanced in order to comply with the specifications of the mobile communication products such as cellular phones, PDAs or the like.

The useful period of time of a cellular phone partly depends on the coupling of a port thereof and an electrical connector. In brief, a durable, high performance electrical connector is critical. Conventionally, a plurality of latch members are provided on the housing of an electrical connector for fastening at inner walls of the port. In detail, a plurality of first latch members are provided on a top of the connector housing and a plurality of second latch members are provided on a bottom thereof in which the number of the first latch members is different from that of the second latch members. The bottom latch members are designed to matingly engage with grooves on the inner walls of the port. For obtaining a reliable fastening at the port, the top latch members should have a sufficient arm of forces. For a small electrical connector, the housing thereof has two latch members on its top. For a large electrical connector (see FIG. 1), the housing (H) thereof has three latch members on its top in which two small auxiliary latches (L1-L1) adjacent both sides are arranged in an inside out manner (i.e., tapered projections at the open ends of the auxiliary latches facing the forward opening of the connector) and a large main latch (L2) in the center is arranged in an outside in manner (i.e., tapered projection at the open end of the main latch extended away from the forward opening of the connector) similar to that of the small electrical connector.

It is understood that the strength of force exerted by the latch member is critical to the fastening of the connector in the port. And in turn, the maximum times of plugging and unplugging of the connector is closely related thereto. In the past, 5,000 times of plugging and unplugging of an electrical connector is acceptable. Nowadays, 10,000 times is required. However, the latch arrangement (e.g., the main latch) of the prior electrical connector has the drawback of short arm of forces, resulting in an unreliable fastening of the connector in the port and poor communication quality therebetween. Moreover, the opposite orientations of the main latch (L2) and the auxiliary latches (L1-L2) can limit a possible extension of the main latch (i.e., the arm length of the main latch (L2) is limited). Thus, the need for improvement still exists.

### SUMMARY OF THE INVENTION

It is an object of the present invention to provide an electrical connector in which the main latch has an increased arm so that the fastening of the connector in the port of an electrical device is strong and reliable and thus the times of plugging and unplugging the connector can be increased significantly.

It is another object of the present invention to provide an electrical connector in which all latch members including the main latch and the auxiliary latches are extended to face the forward opening of the connector in an inside out manner as to further increase the fastening of the connector in the port of the electrical device and increase signal transmission quality.

To achieve the above and other objects, the present invention provides an electrical connector comprising a core assembly; a terminal assembly; and a substantially parallelepiped housing including a latch mechanism on a top, the latch mechanism including two auxiliary latches adjacent both sides and a central main latch; wherein each of the latches has a slightly inclined arm and a tapered projection at an open end of arm, and the main latch is extended from a rear of the top of the housing toward a forward opening of the housing.

The above and other objects, features and advantages of the present invention will become apparent from the following detailed description taken with the accompanying drawings.

### BRIEF DESCRIPTION OF THE DRAWINGS

FIG. 1 is a perspective view of a conventional electrical connector;

FIG. 2 is a top perspective view of a preferred embodiment of electrical connector according to the invention;

FIG. 3 is a bottom perspective view of the electrical connector of FIG. 2; and

FIG. 4 is an exploded perspective view of the electrical connector of FIG. 2.

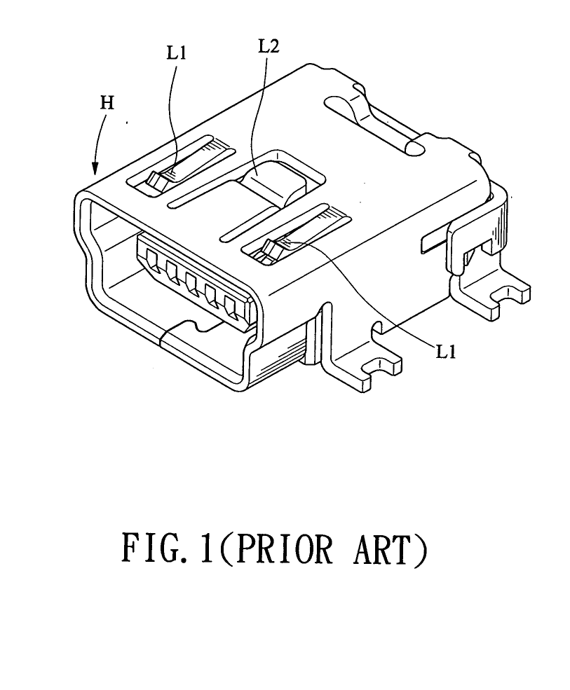

### DETAILED DESCRIPTION OF THE PREFERRED EMBODIMENTS

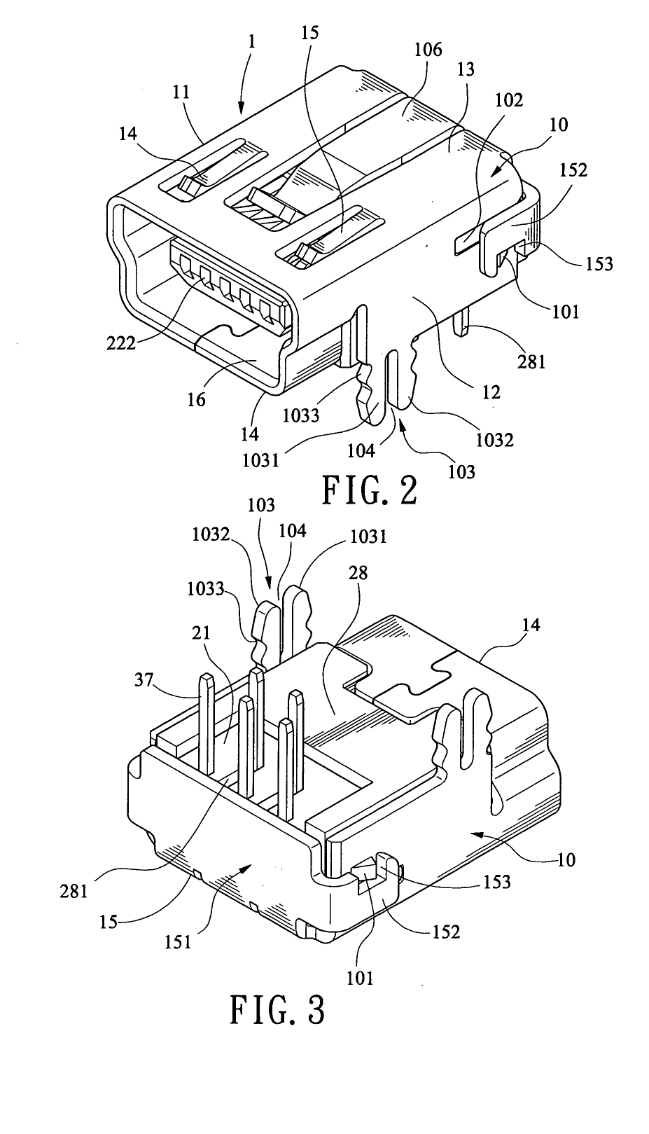

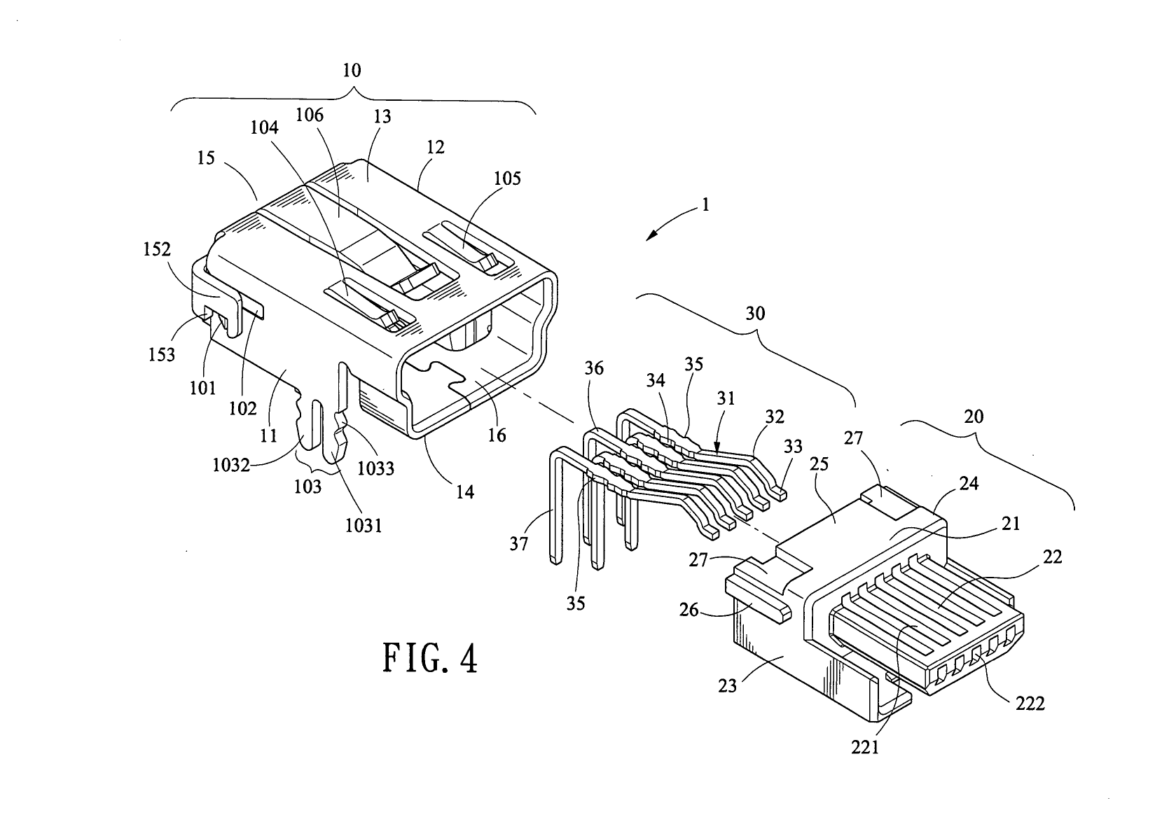

Referring to FIGS. 2 to 4, there is shown an electrical connector 1 constructed in accordance with the invention. The connector 1 comprises a housing 10, a core assembly 20, and a terminal assembly 30. Each component will be described in detail below.

The core assembly 20 comprises a body 21 and a forward rib section 22. An elongated riser 26 is provided on each of both sides 23 and 24. Two edge recesses 27 are provided on a top 25 adjacent the risers 26. A plate 28 (see FIG. 3) is provided on a bottom of the body 21. A plurality of parallel, elongated openings 281 on the bottom of the body 21 adjacent one side of the plate 28. The rib section 22 comprises a plurality of parallel slits 221 and a plurality of parallel channels 222 each disposed below the slit 221 and communicated therewith. The terminal assembly 30 comprises a plurality of L-shaped electrical terminals 31 each having a substantially gabled forward contact 32 projected from the slit 221, a nose portion 33 at an open end of the contact 32, the nose portion 33 being fastened in the slit 221, a flat positioning portion 34 extended from a rear of the contact 32, the positioning portion 34 having a tab 35 at either side fastened in the channel 222, and a bent section 36 having a downward leg 37 inserted through the opening 281( see FIG. 3).

The substantially parallelepiped housing 10, as the unique characteristic of the invention, comprises two tapered protrusions 101 at the rear of both sides 11 and 12, a dent 153 at either bent end 152 of a folded section 151 on a back 15, the dent 153 being adapted to receive and cling onto the tapered protrusion 101, an elongated groove 102 proximate a top of each tapered protrusion 101, the groove 102 being adapted to matingly receive the riser 26, two bifurcated attachment brackets 103 extended downwardly from both sides 11 and 12, each attachment bracket 103 including two elongated pegs 1031 and 1032 spaced apart by a gap 104, and a toothed section 1033 along an outer edge of each of the pegs 1031 and 1032, the toothed sections 1033 being adapted to increase fastening force of the connector coupled to a member. On a top 13 of the housing 10 there are further provided two small auxiliary latches 104 and 105 adjacent both sides 11 and 12 and a large main latch 106 in the center. All of the auxiliary latches 104 and 105 and the main latch 106 are extended toward the forward end of the connector in an inside out manner in which the main latch 106 is extended from a rear of the top 13 so as to obtain a maximum length of an arm thereof. Also, the arm of each of the auxiliary latches 104 and 105 and the main latch 106 is slightly inclined. By configuring as above, a user may insert a forward portion 14 proximate a forward opening 16 into a port of an electronic device in which the tapered projection at the end of each of the auxiliary latches 104 and 105 and the main latch 106 is snapped in a mated cavity on an inner wall of the port. Thus, the fastening is reliable. After considerable experimentation, the electrical connector is able to plug and unplug more than 10,000 times without fail. Moreover, signal transmission quality is improved significantly.

While the invention herein disclosed has been described by means of specific embodiments, numerous modifications and variations could be made thereto by those skilled in the art without departing from the scope and spirit of the invention set forth in the claims.

1. An electrical connector, comprising:
a core assembly;
a terminal assembly; and
a housing including a latch mechanism on a top, the latch mechanism comprising two auxiliary latches adjacent both sides and a central main latch;
wherein each of the latches has a slightly inclined arm and a tapered projection at an open end of arm, and the main latch is extended from a rear of the top of the housing toward a forward opening of the housing.

2. The electrical connector of claim 1, wherein the auxiliary latches and the main latch are extended toward the forward opening of the housing.

3. An electrical connector, comprising:
a core assembly including a body and a forward rib section having a plurality of parallel slits and a plurality of parallel channels, a riser on each of both sides thereof;
a terminal assembly having a plurality of L-shaped electrical terminals each being fastened in the slit and channel of the core assembly; and
a housing being adapted to receive the core assembly therein and including a top, a bottom, a forward opening, a back, and two sides, two tapered protrusions each at a rear of both sides, a dent, at either bent end of a folded section on the back, which is adapted to receive and cling onto the tapered protrusion, an elongated groove, proximate a top of each tapered protrusion, which is adapted to matingly receive the riser of the core assembly, two bifurcated attachment brackets each being extended downwardly from both sides, on the top of the housing further comprising two small auxiliary latches adjacent both sides and a large main latch in a center thereof wherein each of the latches has an arm and a tapered projection at an open end of the arm, and the main latch is extended from a rear of the top of the housing toward the forward opening of the housing so as to obtain a maximum length of the arm thereof.

4. The electrical connector of claim 3, wherein each attachment bracket further comprises a toothed section along an outer edge of each of the pegs, the toothed sections being adapted to increase fastening force of the connector coupled to a member.

5. The electrical connector of claim 4, wherein each attachment bracket further comprises two elongated pegs spaced apart by a gap.

6. The electrical connector of claim 3, wherein the auxiliary latches and the main latch are extended toward the forward opening of the housing.

7. The electrical connector of claim 3, wherein the housing is substantially parallelepiped.

8. The electrical connector of claim 1, wherein the housing is substantially parallelepiped.

9. The electrical connector of claim 1, wherein the latches are extended to face the forward opening in an inside out manner.

10. The electrical connector of claim 3, wherein the latches are extended to face the forward opening in an inside out manner.
